(19) United States
(12) Patent Application Publication
(10) Pub. No.: US 2014/0307964 A1
(43) Pub. Date: Oct. 16, 2014

(54) METHOD AND APPARATUS FOR ADJUSTING BRIGHTNESS OF INPUT IMAGE

(71) Applicants: SAMSUNG ELECTRONICS CO., LTD., Suwon-si (KR); UNIST Academy-Industry Research Corporation, Ulsan (KR)

(72) Inventors: Youn-jin KIM, Pocheon-si (KR); Young-shin KWAK, Ulsan (KR); Seung-ran PARK, Hwaseong-si (KR); Soo-yeon LEE, Ulsan (KR); Seong-wook HAN, Seoul (KR)

(73) Assignees: UNIST Academy-Industry Research Corporation, Ulsan (KR); SAMSUNG ELECTRONICS CO., LTD., Suwon-si (KR)

(21) Appl. No.: 14/248,822

(22) Filed: Apr. 9, 2014

(30) Foreign Application Priority Data
Apr. 10, 2013 (KR) 10-2013-0039508

(51) Int. Cl. G06T 5/00; G06T 7/40

(52) U.S. Cl. CPC G06T 5/009; G06T 7/408
USPC 382/167

(57) ABSTRACT

A method of adjusting a brightness of an input image includes performing brightness conversion on a brightness component value of the input image, and compensating a chroma value of the input image based on input image information and a brightness value obtained from the brightness conversion, wherein the input image information includes a chroma component value and the brightness component value of the input image.

### CROSS-REFERENCE TO RELATED PATENT APPLICATION

This application claims priority from Korean Patent Application No. 10-2013-0039508, filed on Apr. 10, 2013, in the Korean Intellectual Property Office, the disclosure of which is incorporated herein in its entirety by reference.

### BACKGROUND

1. Field

Apparatuses and methods consistent with exemplary embodiments relate to a method and an apparatus for adjusting brightness of an input image in image output devices.

2. Description of the Related Art

To enhance image quality in an image output device, it is important to independently control a hue, a brightness, and a chroma for each pixel in an input image. For example, it is desirable not to affect a color component when a brightness component is adjusted.

In a related art apparatus for adjusting a brightness using a device dependent color space such as a YCbCr color space, a hue, saturation, intensity (HSI) color space, or a hue, saturation, value (HSV) color space, including a brightness signal and a color signal. In case of the YCbCr color space, a YCbCr input signal is divided into a luma component representing a brightness (Y) component (or signal) and a color component by using the device dependent color space. Signal processing such as contrast enhancement, gamma correction, and tone mapping is performed on the brightness (Y) component in the YCbCr input signal and not on the color component thereof. However, since the brightness (Y) component and the color component are not independent of each other in the device dependent color space, a distortion of a color signal may occur when the brightness signal is adjusted.

On the other hand, in a related art apparatus for adjusting a brightness using a device independent color space, after converting an input signal into a device independent color space such as CIELAB or CIECAM02, processing is performed on a brightness signal and not on a color signal. However, although using the device independent color space instead of the device dependent color space may reduce distortion of a color signal while adjusting brightness, the device independent color space requires complicated calculation processes. Thus, it is difficult to use the device independent color space in image output apparatuses requiring real-time computations such as, for example, a digital display, a printer, a digital camera, a digital projector, and a handheld terminal device.

### SUMMARY

Exemplary embodiments may address at least the above problems and/or disadvantages and other disadvantages not described above. Also, the exemplary embodiments are not required to overcome the disadvantages described above, and an exemplary embodiment may not overcome any of the problems described above.

One or more exemplary embodiments provide a method of adjusting a brightness of an input image and an apparatus for performing the method in which a brightness signal of the input image is converted in a device dependent color space.

According to an aspect of an exemplary embodiment, there is provided a method of adjusting a brightness of an input image, including performing brightness conversion on a brightness component value of the input image, and compensating a chroma value of the input image based on input image information and a brightness value obtained from the brightness conversion, wherein the input image information includes a chroma component value and the brightness component value of the input image.

A color space in which the brightness conversion is performed may be a device dependent color space.

The device dependent color space may be one of a YCbCr color space, a hue, saturation, value (HSV) color space, and a hue, saturation, intensity (HSI) color space.

When the brightness conversion is performed in a YCbCr color space, a Y component may be the brightness component and Cb and Cr components may be the chroma component.

The performing and the compensating may be performed in a device dependent color space. A brightness component value and a chroma component value of the input image in a device independent color space may be substantially the same as values obtained by converting, in the device independent color space, a brightness component value that is output after performing the brightness conversion and a chroma component value that is output after compensating the chroma value of the input image.

The brightness conversion may be performed by using at least one from among a predetermined parameter, characteristics of an imaging apparatus for performing the brightness conversion, and an input signal received from an external source.

The brightness conversion and the chroma compensation may be performed for each pixel of the input image.

The method may further include, when the input image is an RGB image, performing a color space conversion on the RGB image and splitting the input image into the brightness component and the chroma component.

The input image information may further include a hue component value of the input image.

According to an aspect of another embodiment, there is provided an apparatus for adjusting a brightness of an input image, including a brightness conversion unit configured to perform brightness conversion on a brightness component value of the input image, and a chroma compensation unit configured to compensate a chroma value of the input image based on input image information and a brightness value obtained from the brightness conversion, wherein the input image information includes a chroma component value and the brightness component value of the input image.

According to an aspect of still another embodiment, there is provided a digital display device including the apparatus for adjusting a brightness of an input image.

According to an aspect of still another exemplary embodiment, there is provided a computer-readable recording medium having recorded thereon a program for executing the method of adjusting a brightness of an input image.

According to an aspect of still another exemplary embodiment, there is provided an apparatus for adjusting a brightness of an input image, the apparatus including a brightness conversion unit configured to perform brightness conversion on a brightness component value of the input image, and a chroma compensation unit configured to predict a variation in a chroma component of the input image occurring during the brightness conversion based on a variation in the brightness component value of the input image and compensate the chroma component of the input image based on the predicted variation.

### BRIEF DESCRIPTION OF THE DRAWINGS

The above and/or other aspects will become more apparent by describing certain exemplary embodiments with reference to the accompanying drawings in which:

FIG. 1 is a block diagram of an apparatus for adjusting a brightness according to an exemplary embodiment;

FIG. 2 illustrates examples of converting a brightness of an input image according to an exemplary embodiment;

FIG. 3 is a flowchart of a method of adjusting a brightness according to an exemplary embodiment;

FIG. 4 is a graph for explaining a method of adjusting a brightness according to an exemplary embodiment;

FIG. 5 is a graph for explaining a method of adjusting a brightness according to an exemplary embodiment;

FIG. 6 is a block diagram of an apparatus for adjusting a brightness according to another exemplary embodiment;

FIG. 7 is a block diagram of an apparatus for adjusting a brightness according to still another exemplary embodiment; and

FIG. 8 is a flowchart of a method of adjusting a brightness according to another exemplary embodiment.

### DETAILED DESCRIPTION

Certain exemplary embodiments are described in greater detail below with reference to the accompanying drawings.

In the following description, the same drawing reference numerals are used for the same elements even in different drawings. The matters defined in the description, such as detailed construction and elements, are provided to assist in a comprehensive understanding of exemplary embodiments. Thus, it is apparent that exemplary embodiments can be carried out without those specifically defined matters. Also, well-known functions or constructions are not described in detail since they would obscure exemplary embodiments with unnecessary detail.

Herein, the term ‘image’ is used to collectively refer to a still image and a moving image such as a video.

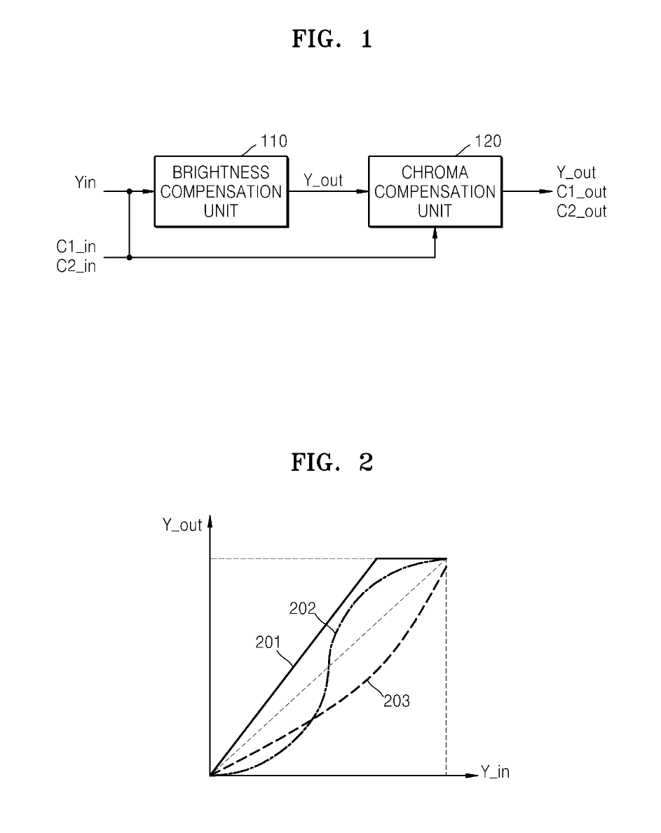

FIG. 1 is a block diagram of an apparatus for adjusting a brightness of an input image according to an exemplary embodiment.

An apparatus for adjusting a brightness of an input image according to an exemplary embodiment includes a brightness conversion unit 110 and a chroma compensation unit 120.

In this exemplary embodiment, it is assumed that a signal of a YCbCr color space is input to the apparatus to be used in an image output device which is a digital display. However, exemplary embodiments are not limited thereto, and the input signal may be correspond to any other device dependent color spaces that include brightness information and chroma information, such as a hue, saturation, value (HSV) color space, a hue, saturation, intensity (HSI) color space, or a hue, saturation, lightness (HSL) color space. The image output device may include, for example, a printer, a digital camera, a digital camcorder, a facsimile, a digital projector, or a handheld terminal device.

The brightness conversion unit 110 converts and adjusts a brightness component value, i.e., Y_in, of an input image and outputs an adjusted value Y_out. For example, as shown in the following Equation (1), the brightness conversion unit 110 may increase or decrease the brightness component value Y_in of the input image by using a predetermined weight Y_weight.

Y_out=Y_in*Y_weight (1)

FIG. 2 illustrates examples of converting a brightness of an input image according to an exemplary embodiment. Referring to FIG. 2, as examples of converting a brightness of the input image, a straight line 201, an S-shaped curve 202, and a gamma curve 203 may be obtained for the adjusted value Y_out with respect to the brightness component value Y_in of the input image by using Equations (2) and (3) below. Shapes of the S-shaped curve 202 and the gamma curve 203 may be changed according to values K1 and K2 in Equation (2) and (3). Furthermore, the values K1 and K2 may be used as parameters which adaptively vary with a hue of the input signal. For example, the values K1 and K2 may vary with each hue region.

$$\begin{matrix}{Y}_{out} = \frac{{Y}_{i n}}{{Y}_{ma x}} + K 1 \cdot sin ( pi \cdot ( 2 \cdot \frac{{Y}_{i n}}{{Y}_{ma x}} - 1 ) ) \cdot {Y}_{ma x} & ( 2 ) \\ {Y}_{out} = {Y}_{i n} \cdot {( \frac{{Y}_{i n}}{{Y}_{ma x}} )}^{K 2} & ( 3 )\end{matrix}$$

wherein Y_in is the brightness component value of the input signal and Yout is an output brightness component value. For example, Ymax may be 255 when the input signal has 8 bits. Here, values of K1 and K2 may be parameters that vary with a hue of the input signal.

When brightness conversion is performed according to the straight line 201 as shown in FIG. 2, the output brightness component value Y_out varies in proportion to the input brightness component value Y_in. When brightness conversion is performed according to the S-shaped curve 202, and the input brightness component value Y_in is smaller, e.g. when the input image is darker, the output brightness component value Y_out decreases compared to the input brightness component value Y_in, according to the S-shaped curve 202. On the other hand, when the brightness component value is larger, e.g., when the input image is brighter, the output brightness component value Y_out increases compared to the input brightness component value Y_in, according to the S-shaped curve 202.

When brightness conversion is performed according to the gamma curve 203 and the input brightness component value is smaller, e.g. when the input image is darker, the output brightness component value Y_out decreases compared to the input brightness component value Y_in, according to the gamma curve 203. Also, when the brightness component value is larger, e.g., when the input image is brighter, the output brightness component value Y_out decreases compared to the input brightness component value Y_in, according to the gamma curve 203.

According to an exemplary embodiment, an input image signal is divided into a brightness component and a chroma component, and the brightness component is converted. However, in a color space such as a device dependent color space where the input image signal is not completely divided into a brightness component and a chroma component, the chroma component varies as the brightness component is changed by the brightness conversion unit 110. Therefore, the chroma variation needs to be compensated for.

That is, since a brightness component is not completely separated from a chroma component in a device dependent color space such as the YCbCr color space, the perceived chroma will be changed as the brightness component is changed.

In an exemplary embodiment, the chroma compensation unit 120 determines a degree to which a chroma change is compensated for by considering chroma C1_in and C2_in of an input image and a variation in the brightness component value of the input image when the brightness component is changed by brightness conversion unit 110. When chroma conversion is performed in the YCbCr color space, C1_in and C2_in refer to values Cb_in and Cr_in, i.e., chroma components Cb and Cr of the input image, respectively. The chroma compensation unit 120 compensates for a variation in a chroma component value of the input image, i.e., a variation in a chroma value. More specifically, the chroma compensation unit 120 predicts a chroma change that occurs during brightness conversion by the brightness conversion unit 110, calculates a chroma compensation value ΔYCC_chroma for compensating for the predicted chroma change, and outputs a value obtained by adding the chroma compensation value ΔYCC_chroma to an input chroma value.

For example, when brightness conversion is performed in the YCbCr color space, the chroma compensation value ΔYCC_chroma may be calculated by using Equation (4) below.

$$\begin{matrix}Δ YCC\_chroma = f ( YCC\_hue , YCC\_chroma , Y\_weight ) \\ = ( a 1 \cdot YCC\_chroma ) ( Y\_weight - 1 )\end{matrix} \qquad ( 4 )$$

In the Equation (4), YCC_hue represents a hue value calculated by using Cb_in and Cr_in that are chroma components Cb and Cr of the input image in the YCbCr color space, i.e., ATAN(Cr_in/Cb_in), and YCC_chroma is a chroma value calculated by using Cb_in and Cb_in that are the chroma components Cb and Cr of the input image in the YCbCr color space, i.e., (Cb_in²+Cr_in²)^{1/2}. Y_weight is a ratio of an input brightness value to an output brightness value. A variable a1 may vary according to an YCC_hue angle or a hue region and may be experimentally determined. A chroma value output from the chroma compensation unit 120, i.e., an output chroma value Y_chroma_out for each pixel, is defined by Equation (5) below.

Y_chroma_out=Y_chroma_in+ΔYCC_chroma (5)

wherein Y_chroma_in is an input chroma value for each pixel, and ΔYCC_chroma is a chroma compensation value for each pixel.

Although it is described that the chroma compensation value ΔYCC_chroma is calculated based on the hue value YCC_hue, the chroma value YCC_chroma of the input image, and the ratio Y_weight of the input brightness value to the output brightness value, exemplary embodiments are not limited thereto. For example, the chroma compensation value ΔYCC_chroma may be obtained based on the brightness value of the input image and chroma value variation.

An apparatus for adjusting a brightness of an input image according to an exemplary embodiment may substantially prevent degradation of an image resolution and image quality due to a change in chroma of an input image, which may occur when performing brightness conversion by using a device dependent color space such as the YCbCr color space that consists of a brightness component and a chroma component.

While in this exemplary embodiment, brightness conversion is performed in the YCbCr color space to improve the brightness, the brightness conversion may also be performed in any other device dependent color spaces such as, for example, the HSV, the HSI, and the HSL color spaces.

Furthermore, according to an exemplary embodiment, it is possible to reproduce substantially the same color gamut in a device dependent color space as a color gamut obtained when hue, brightness, and chroma components of an input image are converted in a device independent color space.

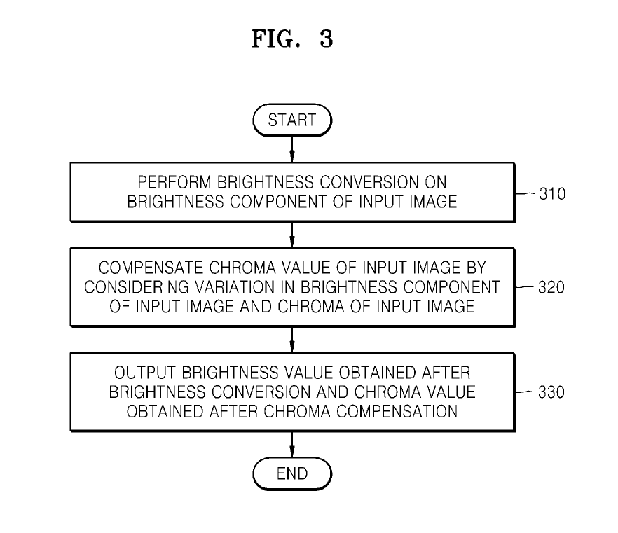

FIG. 3 is a flowchart of a method of adjusting a brightness according to an exemplary embodiment, which may be performed in the apparatus of FIG. 1.

Referring to FIG. 3 a brightness component value or a brightness value of an input image, i.e., a brightness value of a signal Y_in, is converted to be increased or decreased (operation 310). When brightness conversion is performed in the YCbCr color space, Y_in denotes a brightness (Y) value of the input image.

A chroma change which may occur during the brightness conversion is predicted and a chroma compensation value ΔYCC_chroma is calculated to compensate for the predicted chroma change (operation 320). A chroma value may be obtained by adding the chroma compensation value ΔYCC_chroma to an input chroma value Y_chroma_in. According to an exemplary embodiment, a degree of compensating for the predicted chroma change is determined by considering the chroma of the input image and a variation in the brightness component value of the input image. Alternatively, the chroma compensation value ΔYCC_chroma may be calculated according to Equation (4).

Although it is described in this exemplary embodiment that the brightness conversion is performed in the YCbCr color space to improve the brightness, the brightness conversion may be performed in any other device dependent color spaces such as the HSV, the HSI, or the HSL color space.

A brightness value obtained after the brightness conversion and a chroma value obtained after compensating for the predicted chroma change are output (operation 330).

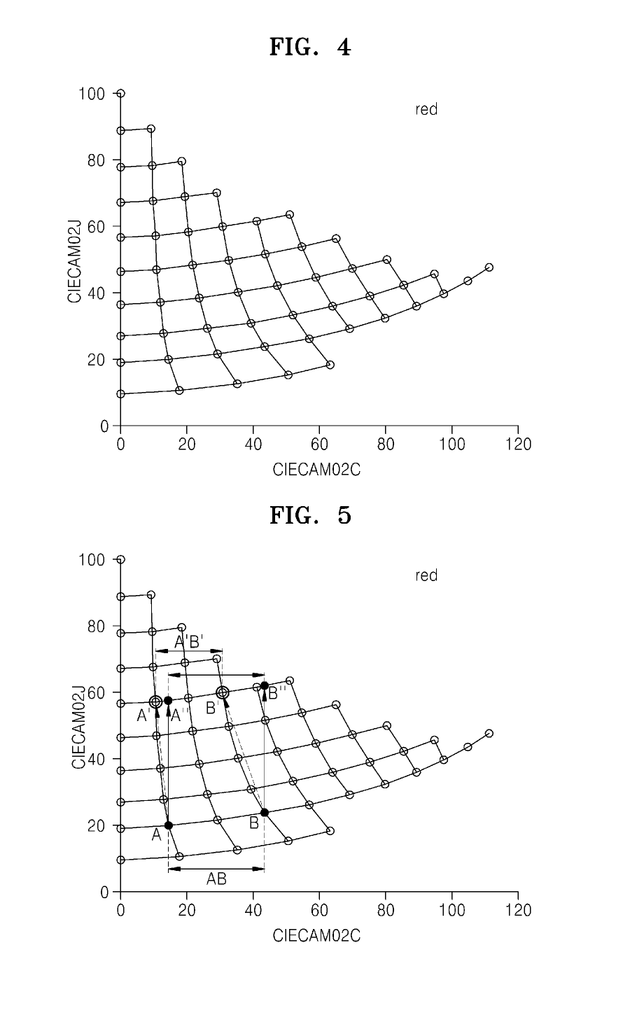

FIG. 4 illustrates representations of colors, which are sampled at predetermined intervals in the YCbCr color space that is a device dependent color space, in a CIECAMO2 Jab color space that is a device independent color space. As shown in FIG. 4, even though chroma component values Cb and Cr remain the same, a chroma value C may vary according to a change in brightness (Y).

In the Jab color space, J represents brightness, a is a color region ranging from a red color RED to a green color GREEN, and b is a color region ranging from a yellow color YELLOW to a blue color BLUE. In FIG. 4, a chroma value C may be calculated according to (a²+b²)^{1/2}.

FIG. 5 shows a case in which positions A and B are changed to positions A′ and B′, respectively, when brightness values of two colors located at the positions A and B are increased by using a related art brightness conversion method in a device dependent color space. In this case, even though the color component values Cb and Cr remain the same, resulting chroma values C of the colors at the positions A′ and B′ are decreased compared to original chroma values C. In particular, when brightness conversion is performed, a higher chroma value is reduced at a greater extent than a lower chroma value. In other words, an interval AB is greater than an interval A′B′, which means that chromatic contrast of the colors at the positions A and B is reduced when brightness values thereof are increased.

As shown in FIG. 5, when the brightness values of the colors at the positions A and B are increased according to an exemplary embodiment, the positions A and B are mapped to positions A″ and B″, respectively. Thus, according to an exemplary embodiment, a chroma change and a reduction in chromatic contrast due to a brightness change may be substantially prevented.

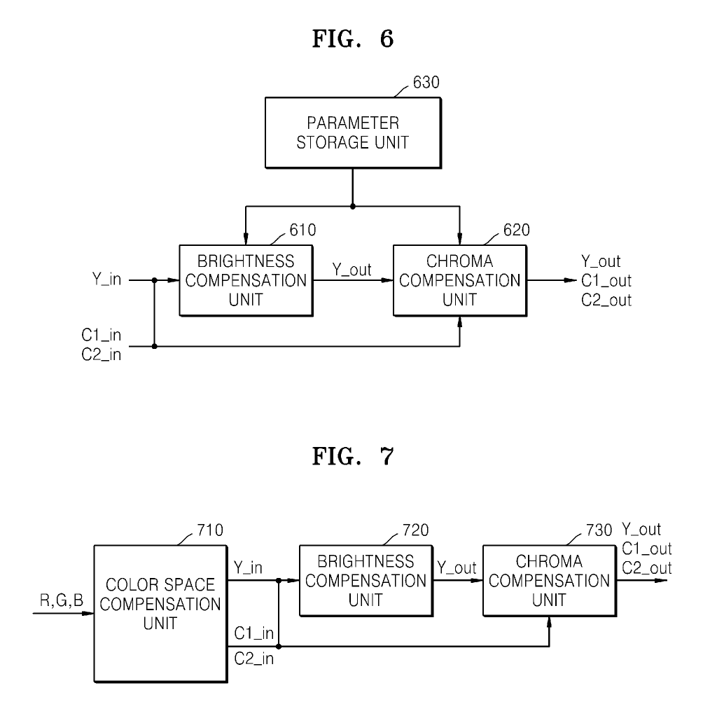

FIG. 6 is a block diagram of an apparatus for adjusting a brightness according to another exemplary embodiment.

Referring to FIG. 6, an apparatus for adjusting a brightness according to another exemplary embodiment includes a brightness conversion unit 610 and a chroma compensation unit 620, which respectively perform substantially the same functions as their counterparts 110 and 120 in the apparatus of FIG. 1, and a parameter storage unit 630.

For convenience of explanation, descriptions of the brightness conversion unit 610 and the chroma compensation unit 620 are omitted herein.

The parameter storage unit 630 stores parameters for performing brightness conversion in the brightness conversion unit 610 and parameters for performing chroma compensation in the chroma compensation unit 620.

The brightness conversion unit 610 and the chroma compensation unit 620 perform brightness conversion and chroma compensation, respectively, using the parameters stored in the parameter storage unit 630.

Although it is described in this exemplary embodiment that the brightness conversion is performed by using the parameters stored in the parameter storage unit 630, the brightness conversion may be performed by another method, e.g., by considering characteristics of an imaging apparatus for performing the brightness conversion or according to an input signal received from an external source.

FIG. 7 is a block diagram of an apparatus for adjusting a brightness according to still another exemplary embodiment.

Referring to FIG. 7, an apparatus for adjusting a brightness according to still another exemplary embodiment includes a brightness conversion unit 710 and a chroma compensation unit 720, which perform substantially the same functions as their counterparts 110 and 120 in the apparatus of FIG. 1, respectively, and a color space conversion unit 710.

The color space conversion unit 710 converts an RGB color space input to the apparatus into the YCbCr color space. Color signals of the RGB color space may be converted into color signals of the YCbCr color space using Equations (6), (7), and (8) below.

Y=(0.257*R)+(0.504*G)+(0.098*B)+16 (6)

Cb=−(0.148*R)−(0.291*G)+(0.439*B)+128 (7)

Cr=(0.439*R)−(0.368*G)−(0.071*B)+128 (8)

While it is described in this exemplary embodiment that a method of adjusting a brightness is performed in the YCbCr color space, the method may be performed in any other color spaces such as the HSV and the HSI color spaces. In this case, the color space conversion unit 710 converts the RGB color space into the HSI or the HSV color space.

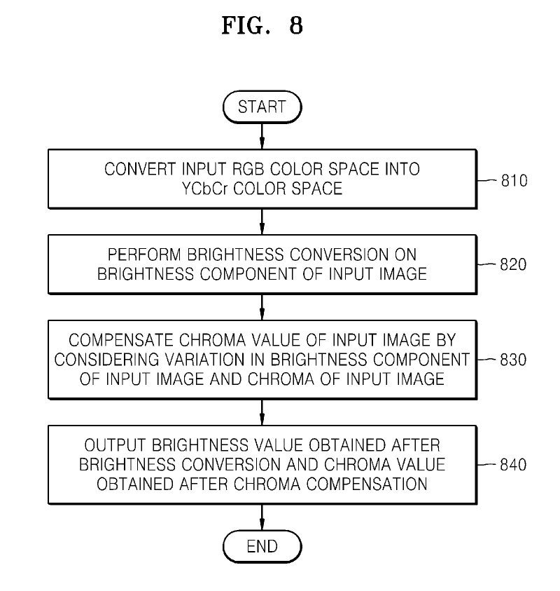

FIG. 8 is a flowchart of a method of adjusting a brightness according to another exemplary embodiment, which may be performed in the apparatus of FIG. 7.

Referring to FIG. 8, an RGB color space input to the apparatus for adjusting a brightness is converted into the YCbCr color space (operation 810). Although it is described that the method of adjusting a brightness according to this exemplary embodiment is performed in the YCbCr color space, the method may be performed in any other color spaces such as the HSV and the HSI color spaces. In this case, in operation 810, the RGB color space may be converted into the HSI or the HSV color space.

A brightness component value or brightness value of an input image, i.e., a brightness value of a signal Y_in, may be converted to be increased or decreased (operation 820). When brightness conversion is performed in the YCbCr color space, Y_in denotes a brightness (Y) value of the input image.

A chroma change which may occur during the brightness conversion is predicted and a chroma compensation value is calculated to compensate for the predicted chroma change (operation 830). A chroma value is obtained by adding the chroma compensation value to an input chroma value. According to an exemplary embodiment, a degree of compensating for the chroma change is determined by considering the chroma of the input image and a variation in the brightness component value of the input image. Alternatively, the chroma compensation value ΔYCC_chroma may be calculated according to Equation (4).

While it is described in this exemplary embodiment that the brightness conversion is performed in the YCbCr color pace to improve the brightness, the brightness conversion may be performed in any other device dependent color spaces such as the HSV, the HSI, and the HSL color spaces.

A brightness value obtained from the brightness conversion and a chroma value obtained by compensating for the chroma change are output (operation 840).

The exemplary embodiments may be embodied by an apparatus that includes a bus coupled to every unit of the apparatus, at least one processor (e.g., central processing unit, microprocessor, etc.) that is connected to the bus for controlling the operations of the apparatus to implement the above-described functions and executing commands, and a memory connected to the bus to store the commands, received messages, and generated messages.

As will also be understood by the skilled artisan, the exemplary embodiments may be implemented by any combination of software and/or hardware components, such as a Field Programmable Gate Array (FPGA) or Application Specific Integrated Circuit (ASIC), which performs certain tasks. A unit or module may advantageously be configured to reside on the addressable storage medium and configured to execute on one or more processors or microprocessors. Thus, a unit or module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. For example, the brightness conversion unit 610 and the chroma conversion unit 620 of FIG. 1 may be embodied as any combination of programmable logic elements or software elements of the processor and the parameter storage unit 630 may be a memory that stores parameters. The functionality provided for in the components and units may be combined into fewer components and units or modules or further separated into additional components and units or modules.

Exemplary embodiments may also be implemented through computer-readable recording media having recorded thereon computer-executable instructions such as program modules that are executed by a computer. Computer-readable media may be any available media that can be accessed by a computer and include both volatile and nonvolatile media and both detachable and non-detachable media. Examples of the computer-readable media may include a read-only memory (ROM), a random-access memory (RAM), a compact disc (CD)-ROM, a magnetic tape, a floppy disk, an optical data storage device, etc. Furthermore, the computer-readable media may include computer storage media and communication media. The computer storage media include both volatile and nonvolatile and both detachable and non-detachable media implemented by any method or technique for storing information such as computer-readable instructions, data structures, program modules or other data. The communication media typically embody computer-readable instructions, data structures, program modules, other data of a modulated data signal such as a carrier wave, or other transmission mechanism, and they include any information transmission media.

The above description of exemplary embodiments is provided for illustration, and it will be understood by those of ordinary skill in the art that various changes in form and details may be made therein without departing from the spirit and scope as defined by the following claims. Thus, the exemplary embodiments described therein should be considered in a descriptive sense only and not for purposes of limitation. For example, each component defined as an integration component may be implemented in a distributed fashion. Likewise, components defined as separate components may be implemented in an integrated manner.

The foregoing exemplary embodiments are merely exemplary and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A method of adjusting a brightness of an input image, the method comprising:
performing brightness conversion on a brightness component value of the input image; and
compensating a chroma value of the input image based on input image information and a brightness value obtained from the brightness conversion, wherein the input image information includes a chroma component value and the brightness component value of the input image.

2. The method of claim 1, wherein a color space in which the brightness conversion is performed is a device dependent color space.

3. The method of claim 2, wherein the device dependent color space is one of a YCbCr color space, a Hue, Saturation, Value (HSV) color space, and a Hue, Saturation, Intensity (HSI) color space.

4. The method of claim 1, wherein when the brightness conversion is performed in a YCbCr color space, a Y component is the brightness component and Cb and Cr components are the chroma component.

5. The method of claim 1, wherein the performing and the compensating are performed in a device dependent color space, and
wherein a brightness component value and a chroma component value of the input image in a device independent color space are substantially the same as values obtained by converting, in the device independent color space, a brightness component value that is output after performing the brightness conversion and a chroma component value that is output after compensating the chroma value of the input image.

6. The method of claim 1, wherein the brightness conversion is performed by using at least one from among a predetermined parameter, characteristics of an imaging apparatus for performing the brightness conversion, and an input signal received from an external source.

7. The method of claim 1, wherein the brightness conversion and the chroma compensation are performed for each pixel of the input image.

8. The method of claim 1, further comprising, when the input image is an RGB image, performing a color space conversion on the RGB image and splitting the input image into the brightness component and the chroma component.

9. The method of claim 1, wherein the input image information further includes a hue component value of the input image.

10. An apparatus for adjusting a brightness of an input image, the apparatus comprising:
a brightness conversion unit configured to perform brightness conversion on a brightness component value of the input image; and
a chroma compensation unit configured to compensate a chroma value of the input image based on input image information and a brightness value obtained from the brightness conversion, wherein the input image information includes a chroma component value and the brightness component value of the input image.

11. The apparatus of claim 10, wherein a color space in which the brightness conversion is performed is a device dependent color space.

12. The apparatus of claim 11, wherein the device dependent color space is one of a YCbCr color space, a Hue, Saturation, Value (HSV) color space, and a Hue, Saturation, Intensity (HSI) color space.

13. The apparatus of claim 10, wherein when the brightness conversion is performed in a YCbCr color space, a Y component is the brightness component and Cb and Cr components are the chroma component.

14. The apparatus of claim 10, wherein the brightness conversion and chroma compensation are performed in a device dependent color space, and
wherein a brightness component value and a chroma component value of the input image in a device independent color space are substantially the same as values obtained by converting, in the device independent color space, a brightness component value that is output after the brightness conversion and a chroma component value that is output after the chroma compensation.

15. The apparatus of claim 10, wherein the brightness conversion is performed by using at least one from among a predetermined parameter, characteristics of an imaging apparatus for performing the brightness conversion, and an input signal received from an external source.

16. The apparatus of claim 10, wherein the brightness conversion and the chroma compensation are performed for each pixel of the input image.

17. The apparatus of claim 10, further comprising a first color space conversion unit that when the input image is an RGB image, performs a color space conversion on the RGB image and splits the input image into the brightness component and the chroma component.

18. The apparatus of claim 10, wherein the input image information further includes a hue component value of the input image.

19. A digital display device comprising the apparatus of claim 10.

20. A computer-readable recording medium having recorded thereon a program for executing the method of claim 1.

21. An apparatus for adjusting a brightness of an input image, the apparatus comprising:
a brightness conversion unit configured to perform brightness conversion on a brightness component value of the input image; and
a chroma compensation unit configured to predict a variation in a chroma component of the input image occurring during the brightness conversion based on a variation in the brightness component value of the input image and compensate the chroma component of the input image based on the predicted variation.

22. The apparatus of claim 21, wherein the chroma compensation unit compensates the chroma component of the input image by adding the predicted variation to the chroma component of the input image.
